(19) United States
(12) Patent Application Publication
(10) Pub. No.: US 2010/0123570 A1
(43) Pub. Date: May 20, 2010

(54) Localized Control Method and Apparatus

(75) Inventors: Nicholas A. Antonopoulos, San Jose, CA (US); F. Eric Saunders, Arnold, CA (US); Charles H. Moore, Sierra City, CA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/338,932

(22) Filed: Dec. 18, 2008

Related U.S. Application Data
(63) Continuation-in-part of application No. 12/272,668, filed on Nov. 17, 2008.

(51) Int. Cl. G08B 23/00; H05B 37/02

(52) U.S. Cl. 340/501; 315/312

(57) ABSTRACT

A zoned interactive control area (10) wherein an architectural space is divided into a plurality of zones (16), each having its own sensor(s) and zone lights (18). The zone lights (18) are controlled by a controller (20) such that there are different lighting levels (55, 57, 59) depending upon whether a zone (16) is occupied, whether an adjacent zone (16)is occupied, whether some other zone (16)is occupied, and the like. A variable control method (50) is adaptable such that fine control and adaptation for special circumstances can be achieved. Other types of devices can also be controlled according to the present inventive method and apparatus.

### CROSS-REFERENCE TO RELATED APPLICATIONS

This application is a continuation-in-part of co-pending U.S. patent application Ser. No. 12/272,668 entitled “Variable Lighting Zones”, filed on Nov. 17, 2008, which is incorporated herein by reference in its entirety.

### BACKGROUND OF THE INVENTION

1. Field of the Invention

The present invention relates to the field of automated control systems, and more particularly to a method and apparatus for allowing complex systems to operate intelligently without a centralized control system. The predominant current usage of the present inventive localized control system is in the control of complex lighting systems, particularly LED lighting systems which are particularly amenable to precision control and which will benefit therefrom by saving power.

2. Description of the Background Art

There are many complex systems that require control of a plurality of devices and which, further, require knowledge of the status of a plurality of different conditions in order to intelligently control each and every such device. An example is an LED lighting system which was disclosed and claimed in U.S. patent application Ser. No. 12/272,668. Much of that disclosure is repeated here below, since the present invention will be described and explained in relation to that example.

An interactive control area 10 which, in this example is a store aisle 12 is disclosed. Typically the aisle 12 which comprises the interactive control area 10 of this example will be bordered by displays 12 which might include shelving, refrigerated storage displays, or the like.

As can be seen in the view of FIG. 1, the interactive control area 10 is divided into a plurality (four, in this present example) of zones 14a, 14b, 14c and 14d. The quantity of zones 14 used for the present example is entirely arbitrary, and in practical applications, the size and quantity of zones will be selected to suit the application. Each of the zones 14 is serviced by a zone light 18a, 18b and 18c and 18d. While the zone lights 18 are depicted as being single separate units in example of the top plan view of FIG. 1, in practical applications each zone light 18 may consist of a plurality of separate lights. Alternatively, in some cases, the zone lights 18 may appear to the viewer to be one continuous light fixture running the length of the aisle 12. In short, the zone lights 18 can be configured, as required, to properly illuminate the interactive control area 10. In any case, since in the present example the zone lights 10 use LED elements for illumination, it is likely that most zone lights 18 will each include a plurality of LED elements therein, such quantity being sufficient to provide the degree of illumination required.

A controller 20 individually controls the light levels of each zone light 18. A plurality of control lines 22 are shown in the view of FIG. 1 connecting the zone lights 18 to the controller. Also, for each zone 16 there is a sensor 24 that senses the presence of a person in each of the zones 16a, 16b, 16c and 16d. Although motion detectors are commonly used in such applications, any of several types of sensors 24 could be used to detect the presence of a person or persons within the zones 16. In order to avoid cluttering the drawing, sensor lines running from the sensors 24 to the controller 20 are omitted from the view of FIG. 1.

As can be appreciated by one skilled in the art, particularly in view of the discussion of the inventive method hereinafter, the controller 20 will have to be capable of a great many operations generally simultaneously in order to perform the necessary steps to control the lighting for even the single interactive control area 10 described in this example. Furthermore, while the inventive method is described herein in relation to only a single aisle 12, in an actual application there may be a large plurality of such aisles 12 or other interactive control areas 10 to be controlled simultaneously, thereby even further requiring either a plurality of controllers 20 or a single controller 20 that possesses sufficient computing power to perform all of the calculations necessary to accomplish multiple iterations of the described inventive method. In the present example, a multi-core SEAforth™ processor, made by IntellaSys™ is utilized for the purpose. One skilled in the art will readily be able to determine how much computing power will be required for a particular application.

FIG. 2 is a flow diagram depicting an example of the inventive variable control method 50. The example of FIG. 2 employs quantities to correspond with the example of FIG. 1, and the inventive variable control method 50 will be described, hereinafter, with reference both to FIG. 2 and to FIG. 1. As can be seen in the view of FIG. 2, in a “sensor input operation” 52 input (consisting of an indication as to whether or not a person or persons is present in each of the zones 16a, 16b, 16c and 16d) is provided from each of the sensors 24 to the controller 20. Then, for each of the zones 16 (in this example, for x=1 to n, where n=4) in an “in zone decision operation” 54 if there is a person or persons within the respective zone 16, then the illumination level of the corresponding zone light 18 will be set to high (HI 56). If and only if there is no person in the respective zone 16, then in an “adjacent zone decision operation” 57 if there is a person or persons in any zone 16 adjacent to the zone 16 presently under consideration, then the illumination level of the corresponding zone light 18 will be set to a medium value (MED 57). If there is no person or persons either in the particular zone 18 under consideration nor in a zone 18 adjacent thereto, the illumination level of the corresponding zone light 18 will be set to a low value (LO 59). These decisions are iterated for each of the zones 18 and then, as can be seen in the view of FIG. 1, input is obtained from each of the sensors 24 to start the process again.

To illustrate by example the above operation, in the view of FIG. 1 a diagrammatic person 26 is illustrated in zone 16b, and no other persons 26 are present in the aisle 12. In this case, the zone light 18b would be set to high, the zone lights 16a and 16c would be set to a medium value, and the zone light 18d would be set to a low value.

Note that while the example illustrated by FIG. 2 shows one way to accomplish the desired objective, the essence of the present invention lies in the fact that a zone 18 with a person or persons therein will have a first (high) illumination level, a zone 18 with a person or persons in an adjacent zone will have a second (medium) lighting level, and zone with no person or persons in that zone or in adjacent zones will have a third (low) lighting level.

As stated above, the example of the inventive variable control method 50 will be repeated, or else accomplished separately and generally simultaneously, for each interactive control area 10 in the area to be illuminated and controlled.

In the present example, a HI 55 illumination level will be essentially 100% of the illumination level of which each of the zone lights 18 is capable. MED 57 illumination level will be approximately 75%, and LO will be approximately 50%. However, it should be noted that these values are examples only. Indeed, in a particular application the values might be “tweaked” at very file levels to achieve the desired lighting effect. Indeed, one of the advantages for using a processor such as the IntellaSys™ SEAforth™ chip is that the illumination of each zone 16 of each interactive control area 10 can be individually controlled, as desired. As just one example, in some applications it might be decided that the proper level for LO 59 would be 0%.

Here ends the discussion of the prior invention that will be used as an example herein. As can be seen in light of the above description, the variable lighting zones and method provide a significant benefit. However, there is considerable complexity involved in the method and in the construction of the apparatus. Clearly, it would be desirable to accomplish the same sort of control in a manner that did not require so many interconnecting wires and so much centralization of control.

### SUMMARY

Accordingly, it is an object of the present invention to provide an apparatus and method to allow devices to operate intelligently based both upon local knowledge and also upon remote knowledge.

It is still another object of the present invention to provide an apparatus and method for sharing information among intelligent devices/

It is yet another object of the present invention to provide an apparatus and method for providing localized control of individual devices where only centralized control was previously possible because information about non-local conditions is required.

Briefly, a known embodiment of the present invention is a meshed network wherein individual devices communicate with other individual devices in order to make localized decisions and take localized action. In the example presented herein, light fixtures each have a detector to detect the presence of a person in a zone served by that fixture. It would be a simple matter merely to adjust the level of light based on whether or not a person was present in that zone. However, as explained in relation to the prior art discussed above, this often produces undesirable results. Therefore, the present invention provides for communication means between its fixture and its neighboring fixture or fixtures such that that light level can be set based on both whether a person is present in the present zone and whether a person is present in a neighboring zone.

In this present example the illumination means is “LED” (light emitting diode) lighting, which lends itself well to instantaneous, rapid, or gradual changes in illumination level without loss of efficiency. Indeed, power savings are generally directly proportional to reduced illumination levels, as opposed to other types of lighting which may lose efficiency as illumination levels are reduced.

These and other objects and advantages of the present invention will become clear to those skilled in the art in view of the description of modes of carrying out the invention, and the industrial applicability thereof, as described herein and as illustrated in the several figures of the drawing. The objects and advantages listed are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the described objects and/or advantages. Accordingly, the objects and/or advantages described herein are not essential elements of the present invention, and should not be construed as limitations.

### BRIEF DESCRIPTION OF THE DRAWINGS

FIG. 1 (prior art) is a diagrammatic top plan view of a store aisle, showing a plurality of illumination zones; and

FIG. 2 (prior art) is a flow diagram showing an example of the present inventive method for controlling variable lighting zones.

FIG. 3 is a diagrammatic top plan view of a store aisle, similar to the view of FIG. 1, illustrating the plurality of illumination zones as applied in the present invention; and

FIG. 4 is a flow diagram showing an example of the present inventive method for providing for local control.

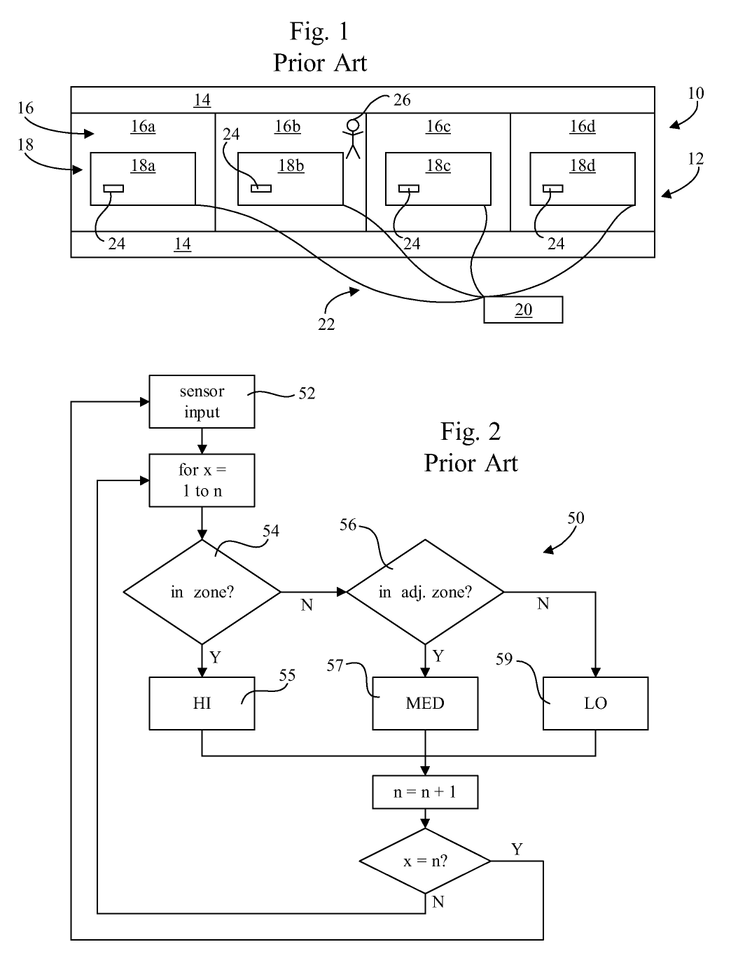

### DETAILED DESCRIPTION OF THE INVENTION

This invention is described in the following description with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

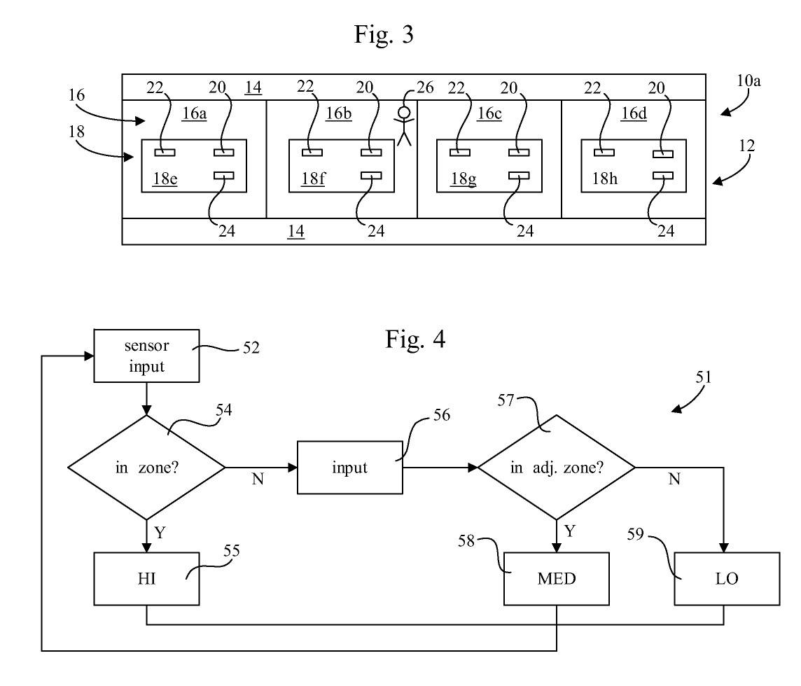

A known mode for carrying out the invention is accomplished by dividing a space into a plurality of zones. An example of an area divided into such zones is depicted in a top plan view in FIG. 3 and is designated therein by the general reference character 10a. In this example, the space 10a is a store aisle 12, like the aisle 12 of FIG. 1, such as an aisle of a supermarket, or the like, although essentially any type of space that is divisible into zones and which may benefit by each zone being served by a separate device of some type, is within the scope of the invention. In this example, typically the aisle 12 which comprises the interactive control area 10a of this example will be bordered by displays 12 which might include shelving, refrigerated storage displays, or the like.

As can be seen in the view of FIG. 3, the space 10a is divided into a plurality (four, in this present example) of zones 14a, 14b, 14c and 14d. The quantity of zones 14 used for the present example is entirely arbitrary, and in practical applications, the size and quantity of zones will be selected to suit the application. Each of the zones 14 is serviced by a zone light 18e, 18f and 18g and 18h.

While the zone lights 18 are depicted as being single separate units in example of the top plan view of FIG. 1, in practical applications each zone light 18 may consist of a plurality of separate lights. Alternatively, in some cases, the zone lights 18 may appear to the viewer to be one continuous light fixture running the length of the aisle 12. In short, the zone lights 18 can be configured, as required, to properly illuminate the interactive control area 10a. In any case, since in the present example the zone lights 18 use LED elements for illumination, it is likely that most zone lights 18 will each include a plurality of LED elements therein, such quantity being sufficient to provide the degree of illumination required.

For each zone 16 there is a sensor 24 that senses the presence of a person in each of the zones 16a, 16b, 16c and 16d. Although motion detectors are commonly used in such applications, any of several types of sensors 24, existing or yet-to-be-invented, could be used to detect the presence of a person or persons within the zones 16.

As can be appreciated by one skilled in the art, particularly in view of the discussion of the inventive method hereinafter, each of the zone lights 18 will have to be capable of independently computing a proper light level. This means that each zone light 18 will have to have a processor 20 that is capable of rapidly performing complex computations but which, also, is both inexpensive (as there will be several to many of them in a complex system), and efficient in that it uses very little power. In the present example, a multi-core SEAforth™ processor, made by IntellaSys™ is utilized for the purpose, since it is very small, inexpensive, and uses very little power. Indeed, since it is completely asynchronous, it uses no power at all when it is not actually performing computations, and cores that are not actually presently in use consume essentially no power even when other cores are actively engaged.

Since the present invention does not use a centralized controller, such as the controller 20 described previously, herein, in relation to the prior art, it must have some means for communicating with the outside world. While this could be accomplished by hard wiring, it could also, and in the present example is, accomplished by a means for allowing each of the zone lights 18 to communicate wirelessly with its neighbor zone lights. Further, while such wireless communication could be accomplished using radio signals, infrared signals (where ambient conditions make this possible), or other such means. In the present example the means of communication is by a light sensor 22, which communicates with the processor. Signals can be sent by flashing one of the zone lights 18 so rapidly that it is imperceptible to humans. Such signals will be in the form of a timed series of flashes that is unique to each zone light 18, such that others of the zone lights 18 will know not only the information that is being sent (which, in this present example will be information pertaining to the presence of a person in another of the zones 16), but also which of the zone lights 18 is sending that information.

It should also be noted that, just because the zone lights 18 of the presently described example of the present invention operate generally without central control, that does not mean that it will not be desirable to have some means for a user to communicate directly with the zone lights 18, for purposes such as changing programming/instructions, or the like. This communication, also, could be accomplished by any of several means, including hard wiring, radio signals, or the like—but in this present example, this communication is also accomplished by flashing lights, which are perceived by the light sensors 22 and interpreted by the processor 20.

FIG. 4 is a flow diagram depicting an example of the inventive variable control method 51. The example of FIG. 4 employs quantities to correspond with the example of FIG. 3, and the inventive variable control method 51 will be described, hereinafter, with reference both to FIG. 4 and to FIG. 3. In accordance with the present invention, each of the operations described hereinafter are accomplished generally independently in each of the plurality of zone lights 18.

As can be seen in the view of FIG. 4, in a “sensor input operation” 52 input (consisting of an indication as to whether or not a person or persons is present in that particular zone 16 is provided from the respective sensor 24. Then, in an “in zone decision operation” 54, if there is a person or persons within the respective zone 16, then the illumination level of the corresponding zone light 18 will be set to high (HI 55). If and only if there is no person in the respective zone 16, then in a “receive input operation” 56 information is received from neighboring zone lights 18 as to whether a person is present within their respective zones 16. It will be noted that several potential problems are involved here which have been addressed by the inventors as follows: As previously described herein, each zone light 18 must be able to particularly identify its neighbors, and this is accomplished by assigning a unique identification flash pattern to each zone light 18. But also, there is the problem that, particularly in large installations, several zone lights may be attempting to communicate simultaneously and it might, therefore, be difficult to decipher the signals at all. Fortunately, a relatively slow response, on the order of more than a second, is acceptable in this particular application. Therefore, there is time for one, or even several, unsuccessful attempts. According to this particular embodiment of the invention, the inventors have found that causing each of the zone lights 18 to broadcast its status at quasi-random intervals ranging from 0.5 seconds to 1.5 seconds, will be more than sufficient to insure, with a high degree of probability, that a successful communication will occur between any two particular zone lights 18 within two seconds. Alternatively, a light shield could be used around the light sensor 22 to make it directionally sensitive, thus generally insuring that any signal received would be from the zone light 18 toward which it is pointed. This is, by no means, an exhaustive list either of the method and means for communicating between the lights, or for the method and/or means for managing communications so as to avoid clashes, and the like.

In an “adjacent zone decision operation” 57 if there is a person or persons in any zone 16 adjacent to the zone 16 presently under consideration, then the illumination level of the present zone light 18 will be set to a medium value (MED 58). If there is no person or persons either in the particular zone 18 under consideration nor in a zone 18 adjacent thereto, the illumination level of the present zone light 18 will be set to a low value (LO 59). The variable control method is repeated, indefinitely, as long as the zone light 18 is in operation.

To illustrate by example the above operation, in the view of FIG. 3 a diagrammatic person 26 is illustrated in zone 16b, and no other persons 26 are present in the aisle 12. In this case, the zone light 18f would set itself to high, the zone lights 18e and 18g would be set, according to their own calculations, to a medium value, and the zone light 18h would set itself to a low value, since there are no persons either in its own zone 16 or in an adjacent zone 16.

Note that while the example illustrated by FIG. 4 shows one way to accomplish the desired objective, the essence of the present invention lies in the fact that a zone 18 with a person or persons therein will have a first (high) illumination level, a zone 18 with a person or persons in an adjacent zone will have a second (medium) lighting level, and zone with no person or persons in that zone or in adjacent zones will have a third (low) lighting level, and all of this is accomplished without any centralized control. That is, the devices (zone lights 18, in this present example) make their own decisions, and they gain the information necessary to make those decisions by communication with other such devices.

In the present example, a HI 55 illumination level will be essentially 100% of the illumination level of which each of the zone lights 18 is capable. MED 58 illumination level will be approximately 75%, and LO 59 will be approximately 50%. However, it should be noted that these values are examples only. Indeed, in a particular application the values might be “tweaked” at very file levels to achieve the desired lighting effect. Indeed, one of the advantages for using a processor such as the IntellaSys™ SEAforth™ chip is that the illumination of each zone 16 of each interactive control area 10 can be individually controlled, as desired. As just one example, in some applications it might be decided that the proper level for LO 59 would be 0%.

It should be noted that, in this present example, the present invention is not limited by the dimming apparatus, or other such method or means as may be employed to change the brightness or other characteristics of the lights. Indeed, it is contemplated by the inventors that dimming means such as duty cycle modulation, or the like, may be employed to control the relative brightness of lights.

Various modifications may be made to the invention without altering its value or scope. For example, while this invention has been described herein in terms of lighting the aisles 12 of a store, many other environments, such as homes, could benefit from the advantages provided by the present invention.

It should be remembered that the quantity of zones 16 illustrated herein (four) could be made greater or lesser, depending upon the size of the area to be illuminated, and such. Also, while the example of the present invention herein has been described as having only three gradient levels (HI 55, MED 27 and LO 59) quite obviously there could be an even greater number of gradient levels such that lighting levels are calculated based not only on the presence of a person within a lighting zone and/or its immediate neighbors, but also upon the presence of a person within more distant neighbors. For example, an additional lighting level (between MED 58 and LO 59) could be provided where there is a person neither in the particular zone 18 nor in its immediate neighbor, but where there is a person in a zone 18 separated from the present zone 18 by one zone 18. A specific example of this, described in relation to the example of FIG. 1 would be that, if such additional gradient level were employed, then zone 18d would be set to that level with the person 26 in zone 16b, as shown. This is, by no means, an exhaustive list of the possible variation of zones and gradients.

Another possible example of a variation of the present invention would be to set lighting levels to account for special circumstances. For example, if there were a particular product in the displays 14 of a particular zone 16, then the controller 20 could be programmed to set the illumination level a zone light 18 or zone lights 18 to highlight that particular zone 16. This could be done by raising the illumination level in that zone 18 higher than the “normal” condition, by lower the level of adjacent zones lower than that of the “normal” condition, or some such combination. (By “normal” what is meant here is the level that would be expected given the operation of the present inventive method described herein, if all zones 16 were treated equally.)

While specific examples of the inventive zoned interactive control area 10 and variable control method 51 have been discussed therein, it is expected that there will be a great many applications for these which have not yet been envisioned. Indeed, it is one of the advantages of the present invention that the inventive method and apparatus may be adapted to a great variety of uses.

Various modifications may be made to the invention without altering its value or scope. For example, while this invention has been described herein in terms of lighting the aisles 12 of a store, many other environments, such as homes, could benefit from the advantages provided by the present invention.

It should be remembered that the quantity of zones 16 illustrated herein (four) could be made greater or lesser, depending upon the size of the area to be illuminated, and such. Also, while the example of the present invention herein has been described as having only three gradient levels (HI 55, MED 58 and LO 59) quite obviously there could be an even greater number of gradient levels such that lighting levels are calculated based not only on the presence of a person within a lighting zone and/or its immediate neighbors, but also upon the presence of a person within more distant neighbors. For example, an additional lighting level (between MED 58 and LO 59) could be provided where there is a person neither in the particular zone 18 nor in its immediate neighbor, but where there is a person in a zone 18 separated from the present zone 18 by one zone 18. A specific example of this, described in relation to the example of FIG. 3 would be that, if such additional gradient level were employed, then zone light 18dh would be set to that level with the person 26 in zone 16b, as shown. This is, by no means, an exhaustive list of the possible variation of zones and gradients.

Another possible example of a variation of the present invention would be to set lighting levels to account for special circumstances. For example, if there were a particular product in the displays 14 of a particular zone 16, then the controller 20 could be programmed to set the illumination level a zone light 18 or zone lights 18 to highlight that particular zone 16. This could be done by raising the illumination level in that zone 18 higher than the “normal” condition, by lower the level of adjacent zones lower than that of the “normal” condition, or some such combination. (By “normal” what is meant here is the level that would be expected given the operation of the present inventive method described herein, if all zones 16 were treated equally.)

While specific examples of the inventive zoned interactive control area 10a and variable control method 51 have been discussed therein, it is expected that there will be a great many applications for these which have not yet been envisioned. Indeed, it is one of the advantages of the present invention that the inventive method and apparatus may be adapted to a great variety of uses.

While the example of the variable control method 51 and related apparatus has been described, herein, in relation to a lighting control device, one skilled in the art will recognize that the invention has application in other types of devices, as well. For example, intelligent fir control devices might benefit from knowing conditions not only in their own vicinity, but also in neighboring vicinities. Thereby, fire sprinklers, or the like, could be triggered by neighboring devices, thereby “getting the jump” on the fire by starting sprinkling (or other fire control measures) before a particular sprinkler's detection system is capable of detecting the fire condition. This is only one example of many that might benefit from application of the present invention.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive zoned interactive control area 10a and associated method 51 are intended to be widely used in a great variety of applications. It is expected that they will be particularly useful in applications wherein both economy and having a pleasant and desirable illumination level are both important considerations. For example, in a store, it would be very uninviting to have the lights off in an aisle, but having a low, but pleasant level, might be even more inviting that a harsh, fully lit level. But as the customer approaches a particular area where he or she will need more light to clearly discern labels, and such, it will be provided. The same principles apply in the home. Instead of having lights suddenly coming on and going off, as with prior art motion detector lighting systems, the pleasant invention will provide a much more pleasant atmosphere—one that will probably actually be used instead of being turned off to avoid the unpleasant experience.

As discussed previously herein, the invention also has application to many other types of devices. An example of an intelligent fire alarm was discussed. Another example might be an intelligent burglar alarm system that does not require wiring or even centralized control. For example, when one detector detects an intruder, other detectors might activate lights, automatic telephone dialers, or other such devices to which they are attached. Yet another of the many possible examples would be an intelligent interactive thermostat system, whereby control of heating elements (furnaces, or the like) is controlled not only by the ambient temperature at the local thermostat, but also by information provided from thermostats in neighboring locations.

Since the zoned interactive control area 10 and variable control method 50 of the present invention may be readily produced and integrated with existing architectural spaces, and the like, and since the advantages as described herein are provided, it is expected that they will be readily accepted in the industry. For these and other reasons, it is expected that the utility and industrial applicability of the invention will be both significant in scope and long-lasting in duration.

### CORRESPONDENCE CHART

10 interactive control area
10a interactive control area
12 aisle
14 displays
16 zones
18 zone lights
18a zone lights
20 processor
22 light sensors
24 sensors
26 person
50 variable control method
51 variable control method
52 sensor input operation
54 in zone decision operation
55 HI level
56 receive input
57 adjacent zone decision operation
58 MED level
59 LO level

What is claimed is:

1. A system, comprising:
a plurality of devices, wherein;
each device has a sensor;
each device has a transmitter for transmitting information derived from its own sensor;
each device has a receiver for receiving information from the transmitters of other devices;
each device has control apparatus for controlling that device based on input both from its own sensor and from at least one sensor of another device.

2. The system of claim 1, wherein:
at least some of the devices are lighting fixtures.

3. The system of claim 2, wherein:
at least some of the devices are LED lights.

4. The system of claim 1, wherein:
at least some of the sensors are detectors for detecting the presence of an object.

5. The system of claim 4, wherein:
at least some of the sensors are motion detectors.

6. The system of claim 1, wherein:
the transmitter is a radio transmitter.

7. The system of claim 1, wherein:
the transmitter includes a flashing light.

8. The system of claim 1, wherein:
the control apparatus includes a processor.

9. The system of claim 8, wherein:
the processor is a multicore array processor.

10. The system of claim 1, wherein:
the devices are lights; and
the brightness of the lights is set depending upon whether each lights own sensor detects the presence of an object, and further upon whether the sensors of neighboring lights sense an object.

11. A method for controlling a plurality of devices, wherein:
each device receives input from an associated sensor;
at least some of the devices receive input from at least some of the other devices; and
at least some of the devices provide an output based on input both from the associated sensor and form the other devices.

12. The method of claim 11, wherein:
the devices are lights.

13. The method of claim 11, wherein:
the sensor is provided to detect the proximity of a person within an area.

14. The method of claim 11, wherein:
the input from at least some of the other devices is input from the sensors of those other devices.

15. The method of claim 11, wherein:
the output includes the illumination output of a light; and
the output is set to a first level when the associated sensor provides a positive indication;
the output is set to a second level when the associated sensor provides a negative indication but at least some of the other devices provide a positive indication; and
the output is set to a third level when neither the associated sensor nor the other devices provide a positive indication.
